(19) United States
(12) Patent Application Publication
(10) Pub. No.: US 2020/0331476 A1
(43) Pub. Date: Oct. 22, 2020

(54) AUTOMATIC LANE CHANGE WITH MINIMUM GAP DISTANCE

(71) Applicant: SF Motors, Inc., Santa Clara, CA (US)

(72) Inventors: Jhenghao Chen, Santa Clara, CA (US); Chen Bao, Santa Clara, CA (US); Fan Wang, Santa Clara, CA (US); Yifan Tang, Santa Clara, CA (US)

(73) Assignees: Chongqing Jinkang New Energy Vehicle, Ltd., Chongqing (CN); SF Motors, Inc., Santa Clara, CA (US)

(21) Appl. No.: 16/237,576

(22) Filed: Dec. 31, 2018

(51) Int. Cl. B60W 30/18; G08G 1/16; B60W 30/16; G05D 1/00; G05D 1/02

(52) U.S. Cl. CPC B60W 30/18163; G08G 1/167; B60W 30/162; G05D 2201/0213; G05D 1/0223; B60W 2550/308; G05D 1/0088

(57) ABSTRACT

An autonomous vehicle automatically implements a lane change in dense traffic condition. A minimum distance gap between the vehicle and a vehicle in front of the present vehicle is calculated for an autonomous vehicle, along with a best trajectory for changing lanes into a left adjacent lane or changing lanes into a right adjacent lane. The left or right lane change is triggered by the driver or the global planner that navigates the vehicle. During the next cycle, pre-calculated information is utilized by a planning module to determine the final speed of the trajectory to complete the final planning trajectory for the lane change.

### BACKGROUND

Automatic lane changes by autonomous vehicles under low speed and dense traffic scenario is a challenging task, primarily due to the limited space between the vehicle making the change and the front vehicle which restricts the vehicle lane change maneuver. Existing automakers are focusing systems that execute lane changes that occur on a freeway. Existing systems cannot make the vehicle perform an auto lane change under extreme low speed in dense traffic conditions.

### SUMMARY

The present technology, roughly described, provides an autonomous vehicle that automatically implements a lane change in dense traffic condition. A minimum distance gap between the vehicle and a vehicle in front of the present vehicle is calculated for an autonomous vehicle, along with a best trajectory for changing lanes into a left adjacent lane or changing lanes into a right adjacent lane. The left or right lane change is triggered by the driver or the global planner that navigates the vehicle. During the next cycle, pre-calculated information is utilized by a planning module to determine the final speed of the trajectory to complete the final planning trajectory for the lane change.

In embodiments, a system for automatically navigating a vehicle between lanes includes a data processing system comprising one or more processors, memory, a planning module, and a control module. The data processing module can generate longitudinal samplings at different velocities by the vehicle, generate a minimum gap distance, between the vehicle and the closest in-path vehicle and based on the longitudinal samplings, required to make a lane change for the vehicle, and select at least one best trajectory from a plurality of trajectories from the current lane to an adjacent lane. The data processing system can also generate one or more commands to navigate the vehicle from the current lane to the adjacent lane along the selected best trajectory, wherein the data processing system automatically controls the vehicle to maintain minimum gap distance between the vehicle and the closest in-path vehicle during the lane change.

In embodiments, a non-transitory computer readable storage medium includes a program, the program being executable by a processor to perform a method for automatically navigating a vehicle between lanes. The method includes generating longitudinal samplings at different velocities by the vehicle, generating a minimum gap distance, between the vehicle and the closest in-path vehicle and based on the longitudinal samplings, required to make a lane change for the vehicle, and selecting at least one best trajectory from a plurality of trajectories from the current lane to an adjacent lane. The method can also include generating one or more commands to navigate the vehicle from the current lane to the adjacent lane along the selected best trajectory, wherein the data processing system automatically controls the vehicle to maintain minimum gap distance between the vehicle and the closest in-path vehicle during the lane change.

In embodiments, a method is disclosed for automatically navigating a vehicle between lanes. The method includes generating, by a data processing system stored in memory and executed by one or more processors, longitudinal samplings at different velocities by the vehicle, and generating, by the data processing system, a minimum gap distance, between the vehicle and the closest in-path vehicle and based on the longitudinal samplings, required to make a lane change for the vehicle. The data processing system can select at least one best trajectory from a plurality of trajectories from the current lane to an adjacent lane, and can generate one or more commands to navigate the vehicle from the current lane to the adjacent lane along the selected best trajectory, wherein the data processing system automatically controls the vehicle to maintain minimum gap distance between the vehicle and the closest in-path vehicle during the lane change.

### BRIEF DESCRIPTION OF FIGURES

FIG. 1 is a block diagram of an autonomous vehicle.

FIG. 2A is a block diagram of a data processing system within an autonomous vehicle.

FIG. 2B is a block diagram of a planning module.

FIG. 3 is a method for implementing a lane change with a minimum gap distance.

FIG. 4 is a method for receiving and processing perception data to generate an object list and lane detection data.

FIG. 5 is a method for planning a change from a center reference line in one lane to a center reference line in an adjacent lane.

FIG. 6 is a method for evaluating and ranking generated trajectories.

FIG. 7 is a method for performing a safety check.

FIG. 8 illustrates a distance gap calculated by previous systems.

FIG. 9 illustrates a distance gap calculated by the current systems.

FIG. 10 is a block diagram of a computing environment for implementing a data processing system.

### DETAILED DESCRIPTION

The present technology, roughly described, provides an autonomous vehicle that automatically implements a lane change in dense traffic condition. A minimum distance gap between the vehicle and a vehicle in front of the present vehicle is calculated for an autonomous vehicle, along with a best trajectory for changing lanes into a left adjacent lane and changing lanes into a right adjacent lane. Lane change time with constant speed longitudinal profile is also generated. During the next cycle, this pre-calculated information is utilized by a planning module to determine the final speed of the trajectory to complete the final planning trajectory for the lane change. The present technology performs lane changes in dense traffic situations that are not possible by other systems.

The technical problem addressed by the present technology involves safely and successfully navigating from a current lane to an adjacent lane in dense traffic situations. Typical automated lane change systems require a significant amount of empty space in the current lane and then adjacent lane before the lane change may be considered. In dense traffic situations, the required amount of empty space is simply not available. As a result, prior lane change systems are unable to make safe lane changes, or anything change at all, and a dense system. This issue in autonomous computer-controlled vehicles results in an inefficient navigation and, often times, a failure to navigate to a desired point.

The present technology provides a technical solution to the technical problem of safely and effectively implementing a lane change in dense traffic situations in which there is little or no pre-existing space between vehicles in an adjacent lane to which the autonomous vehicle intends to navigate. The solution is to plan for a large enough gap and selecting the best trajectory into either the left or the right adjacent lane. During the cycle subsequent to the planning, the lane change planning can be finalized and executed. The solution provided by the present system enables very much more efficient navigation of an autonomous vehicle, thereby reducing computing resources used by the system to navigate the autonomous vehicle to a destination.

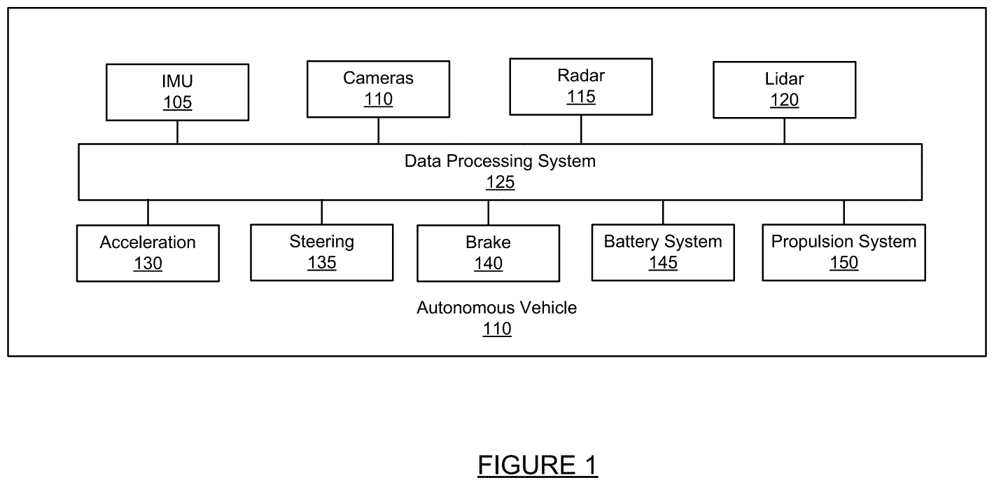

FIG. 1 is a block diagram of an autonomous vehicle. The autonomous vehicle 110 of FIG. 1 includes a data processing system 125 in communication with an inertia measurement unit (IMU) 105, cameras 110, radar 115, and lidar 120. Data processing system 125 may also communicate with acceleration 130, steering 135, breaks 140, battery system 145, and propulsion system 150. The data processing system and the components to communicate with are intended to be exemplary for purposes of discussion. It is not intended to be limiting, and additional elements of an autonomous vehicle may be implemented in a system of the present technology, as will be understood by those of ordinary skill in the art.

IMU 105 may track and measure the autonomous vehicle acceleration, yaw rate, and other measurements and provide that data to data processing system 125.

Cameras 110, radar 115, and lidar 120 may form all or part of a perception component of autonomous vehicle 110. The autonomous vehicle may include one or more cameras 110 to capture visual data inside and outside of the autonomous vehicle. On the outside of the autonomous vehicle, multiple cameras may be implemented. For example, cameras on the outside of the vehicle may capture a forward-facing view, a rear facing view, and optionally other views. Images from the cameras may be processed to detect objects such as streetlights, stop signs, lines or borders of one or more lanes of a road, and other aspects of the environment for which an image may be used to better ascertain the nature of an object than radar. To detect the objects, pixels of images are processed to recognize objects, and singular images and series of images. The processing may be performed by image and video detection algorithms, machine learning models which are trained to detect particular objects of interest, and other techniques.

Radar 115 may include multiple radar sensing systems and devices to detect objects around the autonomous vehicle. In some instances, a radar system may be implemented at one or more of each of the four corners of the vehicle, a front of the vehicle, a rear of the vehicle, and on the left side and right side of the vehicle. The radar elements may be used to detect stationary and moving objects in adjacent lanes as well as in the current lane in front of and behind the autonomous vehicle. Lidar may also be used to detect objects in adjacent lanes, as well as in front of and behind the current vehicle.

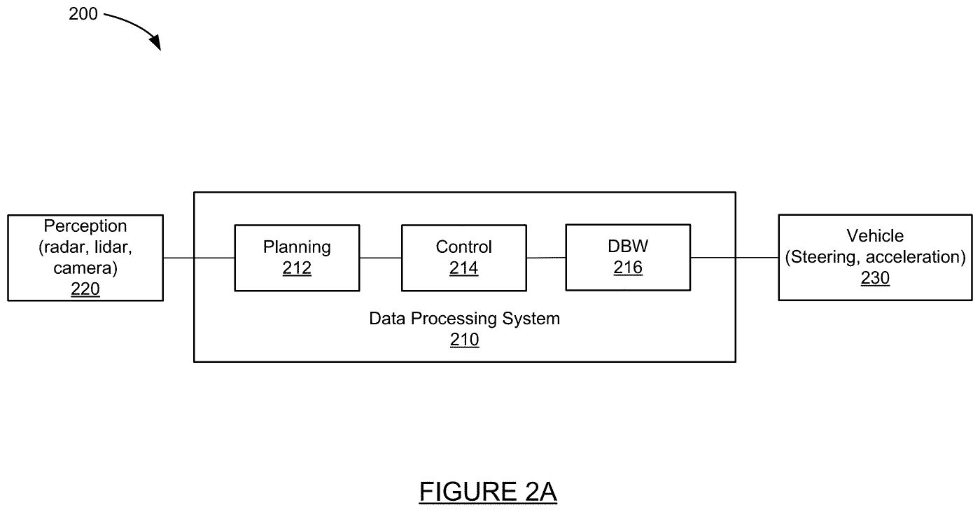

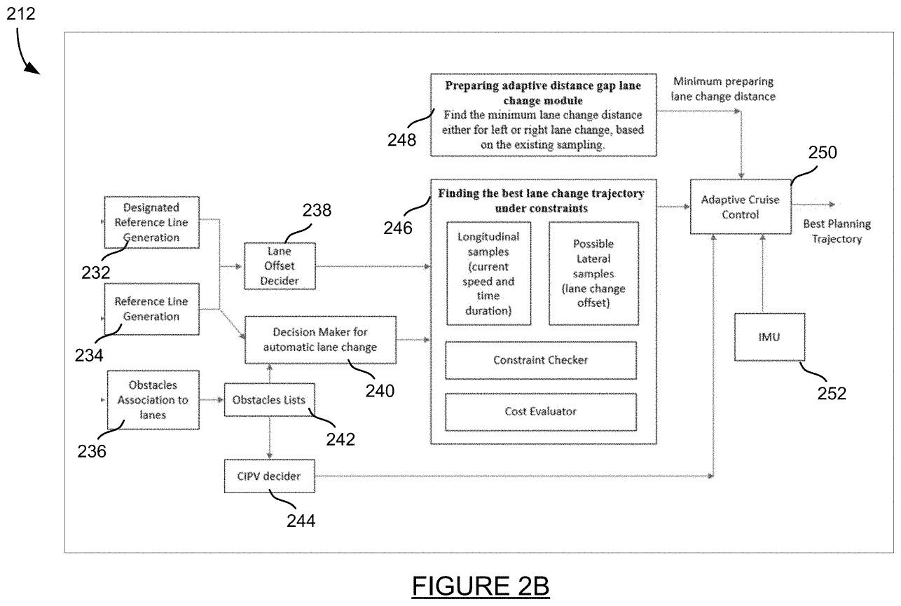

Data processing system 125 may include one or more processors, memory, and instructions stored in memory and executable by the one or more processors to perform the functionality described herein. In some instances, the data processing system may include a planning module, a control module, and a drive-by wire module. The modules communicate with each other to receive data from a perception component plan actions such as lane changes, and generate commands to execute lane changes. The data processing system 125 is discussed in more detail below with respect to the system of FIG. 2A.

Acceleration 130 may receive commands from the data processing system to accelerate. Acceleration 130 may be implemented as one or more mechanisms to apply acceleration to the propulsion system 150. Steering module 135 controls the steering of the vehicle, and may receive commands to steer the vehicle from data processing system 135. Brake system 140 may handle braking applied to the wheels of autonomous vehicle 110, and may receive commands from data processing system 125. Battery system 145 may include a battery, charging control, battery management system, and other modules and components related to a battery system on an autonomous vehicle. Propulsion system 150 may manage and control propulsion of the vehicle, and may include components of a combustion engine, electric motor, drivetrain, and other components of a propulsion system utilizing an electric motor with or without a combustion engine.

FIG. 2A is a block diagram of a data processing system within an autonomous vehicle. Data processing system 210 provides more detail for data processing system 125 of the system of FIG. 1. Data processing system may receive data and information from perception component to 20. Perception component 220 may include radar and camera elements, as well as logic for processing the radar and camera output to identify objects of interest, lane lines, and other elements. Perception 220 may provide a list of objects and lane detection data to planning module 212.

Planning module 212 may receive and process data and information received from the perception component to plan actions for the autonomous vehicle. The actions may include navigating from the center of the lane to an adjacent lane with a minimum gap distance between the present vehicle and the closest in path vehicle (CIPV), navigating from a current lane to adjacent lane, stopping, accelerating, turning, and performing other actions. Planning module 212 may generate samples of trajectories between two lines or points, analyze and select the best trajectory, and provide a best trajectory for navigating from one point to another to control 214. Planning module is discussed in more detail with respect to the system of FIG. 2B.

Control module may receive information from the planning module, such as a selected trajectory over which a lane change should be navigated. Control module 214 may generate commands to be executed in order to navigate the selected trajectory. The commands may include instructions for accelerating, breaking, and turning to effectuate navigation along the best trajectory.

Drive-by wire module 216 may receive the commands from control 214 and actuate the autonomous vehicle navigation components based on the commands. In particular, drive-by wire 216 may control the accelerator, steering wheel, brakes, and turn signals of the autonomous vehicle.

FIG. 2B provides more detail for the planning module 212 of FIG. 2A. The planning module 212 of FIG. 2B receives designated reference line generation 232, reference line generation 234, and obstacles 236 associated to lanes from a perception module. The data is processed to make decision related to performing a lane change. For example, lane offset decider 238 receives designated reference line generation 232 and reference line reference line generation, and operates to decide a lane offset from at least the received generation information. Obstacles list 242 is generated by the planning module from obstacle associations to lanes 236 and provided to decision maker for automatic lane change 240 and CIPV decider 244.

The logic for finding the best lane change directory under constraints 246 receives the lane offset from decider 238 and the lane change decision from decision maker 240 and determines the best lane change. Module 246 determines longitudinal samples for current speed and time duration and possible lateral samples for lane change offset, based at least in part on the received decisions from decider 238 and decider 240, and checks constraints and costs for each sampling. Module 246 then provides the best lane change trajectory data to adaptive cruise control 250. In some instance, the sampling and/or the determination of the best trajectory can be determined continuously in each computing cycle. Minimum (e.g. adaptive) distance gap preparation module finds the minimum lane change distance for the left or right lane change—the minimum gap distance—based on existing sampling. In some instances, the existing sampling is provided from sampling created from module 246 during previous computing cycles, and the minimum distance gap is determined continuously in each computing cycle. The minimum gap distance used to indicate the minimum distance to make a lane change is continuously provided to adaptive cruise control (ACC) 250 along with the best lane change trajectory. ACC also receives yaw rate, acceleration data, and optionally other data from IMU 252, and receives information regarding the closest in-path vehicle from CIPV module 244. The ACC 250 then outputs the best planning trajectory to the control module.

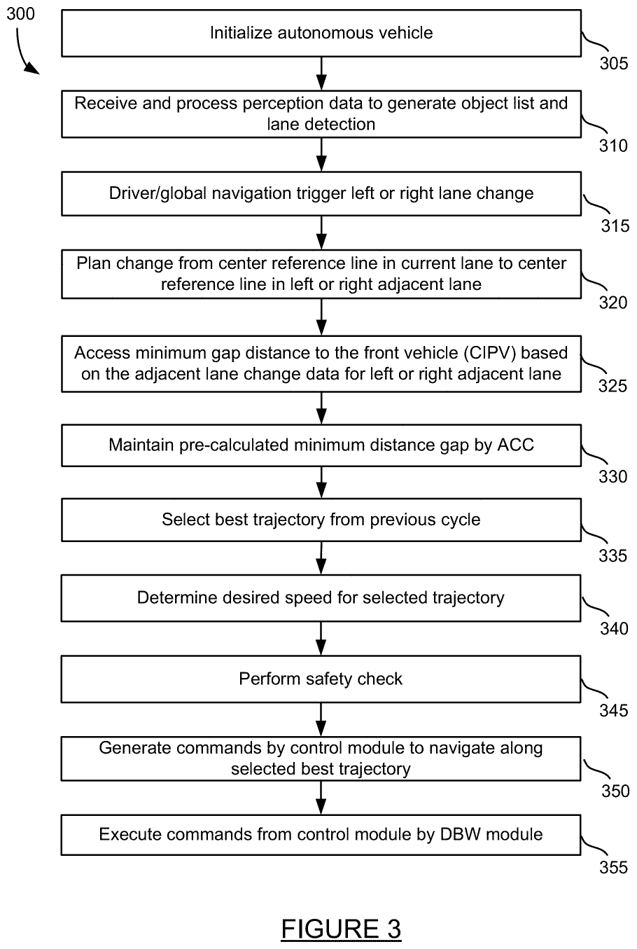

FIG. 3 is a method for implementing a lane change by an autonomous vehicle. The autonomous vehicle is initialized at step 305. Initializing the autonomous vehicle may include starting the autonomous vehicle, performing an initial system check, calibrating the vehicle to the current ambient temperature and weather, and calibrating any systems as needed at startup.

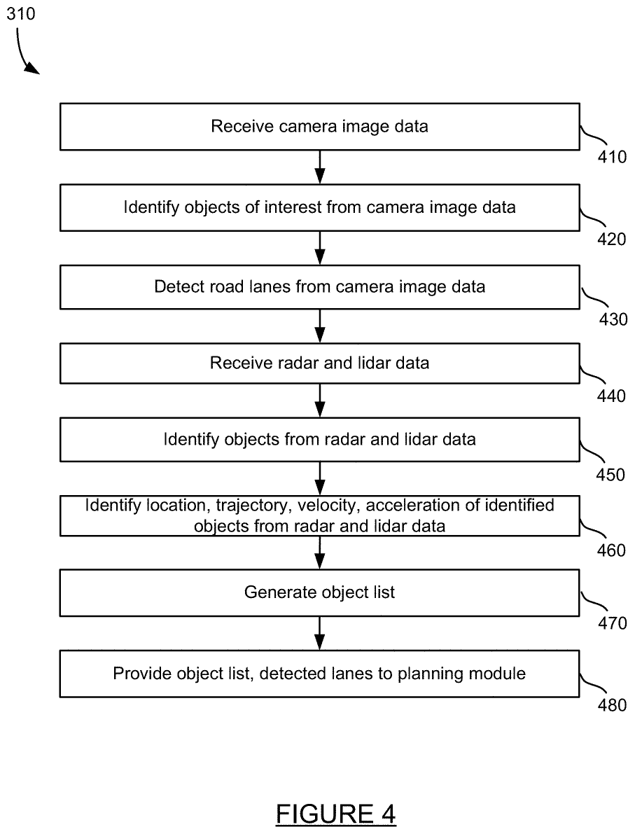

Perception data is received and processed to generate an object list and lane detection data at step 310. Perception data may include image data from one or more cameras, data received from one or more radars and lidar, GPS data, and other data. The perception data may be received by the perception component and may be processed by logic associated with the perception component. Once the object list and lane detection data are generated, they are provided to the data processing system. In some instances, receiving and processing perception data is performed on an ongoing basis, and the listed order of step 310 is for purposes of discussion only with respect to method of FIG. 3. More details for receiving and processing perception data is discussed with respect to the method of FIG. 4.

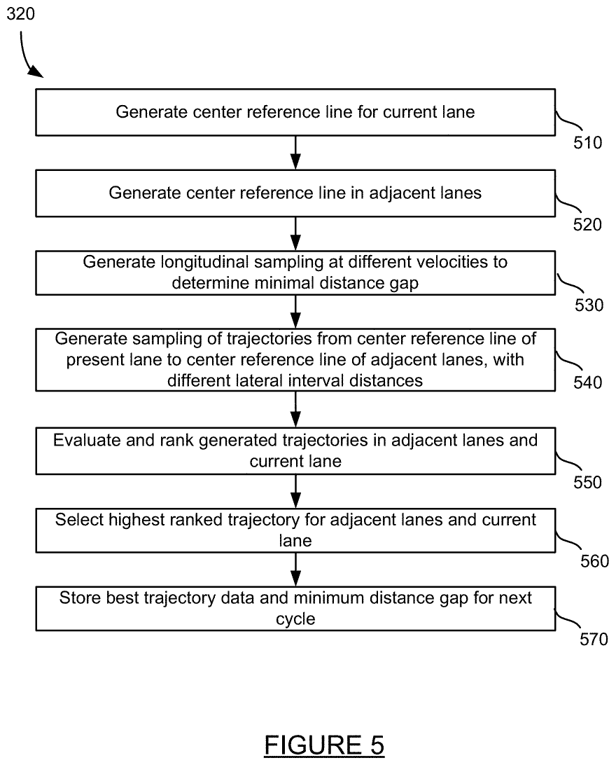

A driver or global navigation system can trigger a left or right lane change at step 315. The triggering even may include a voice command received from a user, detection of less traffic in an adjacent lane, a navigation plan to a selected destination, or other triggering event. The data processing system may plan a lane change in dense traffic at step 320. The lane change may be in response to the triggering event at step 320, and may utilize the object list and lane detection data received at step 310. The lane change deciding process, for a lane change in dense traffic, can include deciding to stay in the current lane, or planning a change from a center reference line in a current lane to a center reference line in an adjacent lane. Lane change planning can be performed all or in part by planning module 212 Planning a lane change in dense traffic from a center reference line in a current lane to a center reference line in an adjacent lane may include generating a plurality of sampled trajectories, analyzing the trajectories to determine the best trajectory for each lane, determining a minimum gap distance in which to perform the lane change, and selecting the best trajectory. More details for planning a lane change to an adjacent lane is discussed with respect to the method of FIG. 5.

The accessed minimum gap distance to the front vehicle (CIPV) based on the adjacent lane change data for the left or right adjacent lane is accessed at step 325. The minimum gap distance is accessed by the ACC unit and used to maintain the pre-calculated minimum distance between the current vehicle and the CIPV at step 330. The minimum gap distance is provided to the ACC on a continuing basis, for example in the computing cycle immediately following the cycle in which the minimum gap distance was calculated. Other data may be accessed by the ACC as well, including the closest in path vehicle information, IMU data, and best trajectories for a lane change.

The best trajectory is selected from the trajectories determined for each adjacent lane during the previous cycle and accessed at step 325, for example by the ACC unit. The desired speed for the selected trajectory is determined at step 335. The desired speed is determined from a sampling of speeds generated in the previous cycle and accessed by the planning module (e.g., ACC unit). In some instances, the ACC unit of the planning module may determine the best speed at which to navigate the selected trajectory based on detected objects and gap distances.

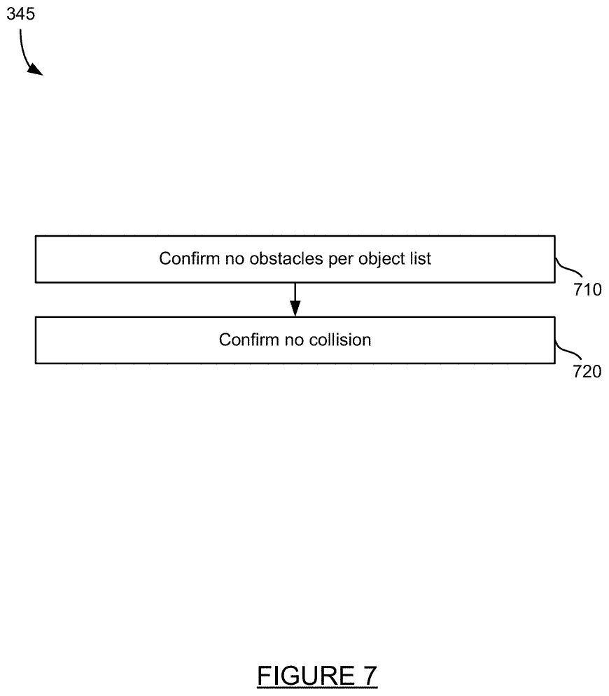

A safety check is performed at step 340. A safety check may include confirming all obstacles exist along the selected trajectory, no collisions will occur along the selected trajectory, and that the autonomous vehicle can physically navigate along the selected trajectory. More details for performing a safety check are discussed with respect to FIG. 7.

The control module generates commands to navigate the autonomous vehicle along the selected trajectory at step 345. The commands may include how and when to accelerate the vehicle, apply braking by the vehicle, and the angle of steering to apply to the vehicle and at what times. The commands are provided by the control module to the drive-by wire module. The generated commands are executed by the drive-by wire module at step 350. The drive-by wire module may control the autonomous vehicle brakes, acceleration, and steering wheel, based on the commands received from the control module. By executing the commands, the drive-by wire module makes the autonomous vehicle proceed along the selected trajectory from the center reference line in the current lane to the center reference line in the selected adjacent lane.

FIG. 4 is a method for receiving and processing perception data to generate an object list and lane detection data. The method of FIG. 4 provides more detail for step 310 of the method of FIG. 3. First, camera image data is received at step 410. The camera image data may include images and/or video of the environment through which the autonomous vehicle is traveling. Objects of interest may be identified from the camera image and/or video data at step 420. Objects of interest may include a stop light, stop sign, other signs, and other objects of interest that can be recognized and processed by the data processing system. In some instances, image data may be processed using pixel clustering algorithms to recognize certain objects. In some instances, pixel data may be processed by one or more machine learning models are trained to recognize objects within images, such as traffic light objects, stop sign objects, other sign objects, and other objects of interest.

Road lanes are detected from the camera image data at step 430. Road lane detection may include identifying the boundaries of a particular road, path, or other throughway. The road boundaries and lane lines may be detected using pixel clustering algorithms to recognize certain objects, one or more machine learning models trained to recognize road boundary and lane line objects within images, or by other object detection methods.

Radar and lidar data are received at step 440, and the radar and lidar data may be processed to identify objects within the vicinity of the autonomous vehicle, such as between zero and several hundred feet of the autonomous vehicle at step 450. The processed radar and lidar data may indicate the speed, trajectory, velocity, and location of an object near the autonomous vehicle (step 460). Examples of objects detectable by radar and lidar include cars, trucks, people, and animals.

An object list of the objects detected via radar, lidar, and objects of interest from the camera image data is generated at step 470. For each object in the list, information may be included such as an identifier for the object, a classification of the object, location, trajectory, velocity, acceleration of the object, and in some instances other data. The object list, road boundaries, detected lanes is provided to a planning module at step 480.

FIG. 5 is a method for planning a change from a center line in a current lane to a center line in an adjacent line. The method of FIG. 5 provides more detail for step 320 of the method of FIG. 3. As such, the method of FIG. 5 may be performed for each adjacent lane with respect to the current lane. In scenarios in which there are two adjacent lines, one on either side of the current lane, one or more steps of the method of FIG. 5 may be performed twice—once to plan a change from a center reference line in the current lane to a center reference line in a left side adjacent lane and once to plan a change to a center reference line in a right-side adjacent lane. For purposes of discussion, FIG. 5 will be discussed with respect to a change to a left side lane change, though it is understood that the method of FIG. 5 is performed for both a left side and right-side planned lane change.

A center reference line for a current lane is generated at step 510. The center reference line is generated by detecting the center of the current lane, which is detected from camera image data. A center reference line in an adjacent lane on the left is then generated at step 520. A longitudinal sampling to determine the minimum gap distance is generated at step 530. The sampling determines the distance and times at which the current vehicle would reach the closest vehicle in the current lane different velocities. The sampling data is used the planning module (e.g., ACC), and the ACC then determine the best speed at which to proceed with the lane change to a selected adjacent lane.

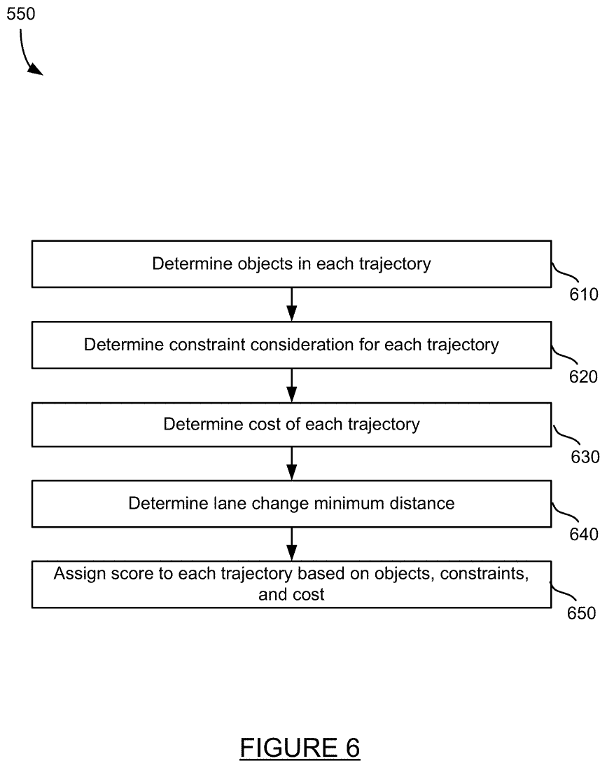

A sampling of trajectories from the center reference line of the current lane to the center reference line of the adjacent lanes, along with different lateral interval distances, is generated at step 540. The sampling of trajectories may include a variety of trajectories from the center reference to various points along any adjacent lane center reference lines. Each generated trajectory is evaluated and ranked at step 550. Evaluating each trajectory within the plurality of sample trajectory lines includes determining objects in each trajectory, determining constraint considerations, and determining the cost of each trajectory. Evaluating and ranking the generated trajectories is discussed in more detail below with respect to the method of FIG. 6. The highest ranked trajectory is selected at step 560 and stored by the planning module. The best trajectory may be accessed by the planning module during the next cycle as part of performing the lane change.

FIG. 6 is a method for evaluating and ranking generated trajectories. The method of FIG. 6 provides more detail for step 550 of the method of FIG. 5. For each factor in the ranking of a trajectory, the ranking is increased or decreased based on the outcome of a determination. For example, if a determination suggests that a trajectory may not be safe, the ranking may be cut in half or reduced by a certain percentage. In some instances, some determinations may have a higher weighting than others, such as for example objects detected to be in the particular trajectory.

Any objects determined to be in a trajectory are identified at step 610. When an object is determined to be in a particular trajectory, the ranking of that battery is reduced, in order to avoid collisions with the object while navigating the particular trajectory. Constraint considerations for each trajectory are determined at step 620. In some instances, one or more constraints may be considered for each trajectory. The constraints may include a lateral boundary, lateral offset, lateral speed, lateral acceleration, lateral jerk, and curvature of lane lines. Each constraint may increase or reduce the ranking of a particular trajectory based on the value of a constraint and thresholds associated with each particular constraint. A cost of each sample trajectory is determined at step 630. Examples of costs include a terminal offset cost, average offset costs, lane change time duration cost, lateral acceleration costs, and lateral jerk cost. When determining a cost, the ranking may be decreased if a particular cost-a threshold or out of a range, and the ranking may be increased if the cost is below a threshold, or within a desired range. A lane change minimum distance is determined at step 640. The lane change minimum distance is the minimum distance required to achieve the lane change into a particular lane. A score is assigned to each trajectory at step 650 based on analysis of the objects in the trajectory, constraints considered for the trajectory, and costs associated with each trajectory.

FIG. 7 is a method for performing a safety check. Performing a safety check for the method of FIG. 7 provides more detail for step 340 of the method of FIG. 3. First, the data processing system confirms that there are no obstacles along the selected trajectory at step 710. The system may confirm that the objects in the object list are not positioned in the trajectory as well as any new objects detected by radar, lidar, or camera data. A confirmation that no collisions will occur is performed at step 720. Collisions may be detected to occur if an unexpected curvature in the road occurs, an unexpected boundary within a road is detected, or some other unforeseen obstacle appears in the selected trajectory.

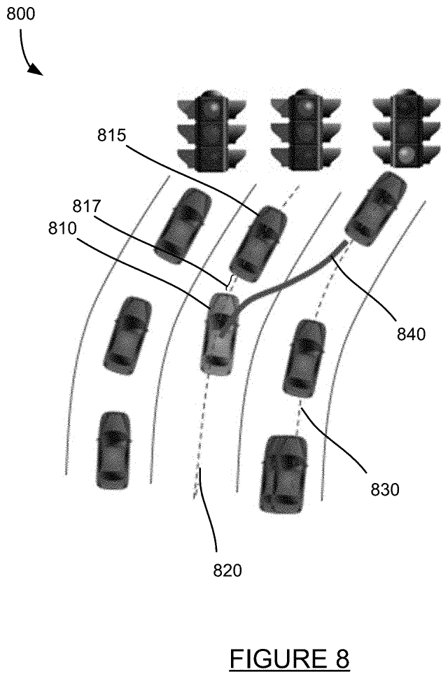

The process of performing a lane change in dense traffic conditions requires, among other things, that a vehicle be aware of and plan to change lanes with more space between the vehicle and a vehicle in front of it in the same lane. Typical cruise control systems do not provide for leaving this much space in front of a vehicle, and therefore typical cruise control systems cannot achieve lane changes in dense traffic. As illustrated in the illustration of FIG. 8, vehicle 810 intends to change lanes in dense traffic among six other cars immediately surrounding vehicle 810. The space 817 typically allocated between a vehicle 810 and the vehicle 815 in front of it is not enough space to perform a lane change in dense traffic conditions. Rather, when a center reference line 820 is generated and a center reference line 830 reference line in an adjacent lane is created, the best trajectory 840 for making the lane change requires more space than space 817.

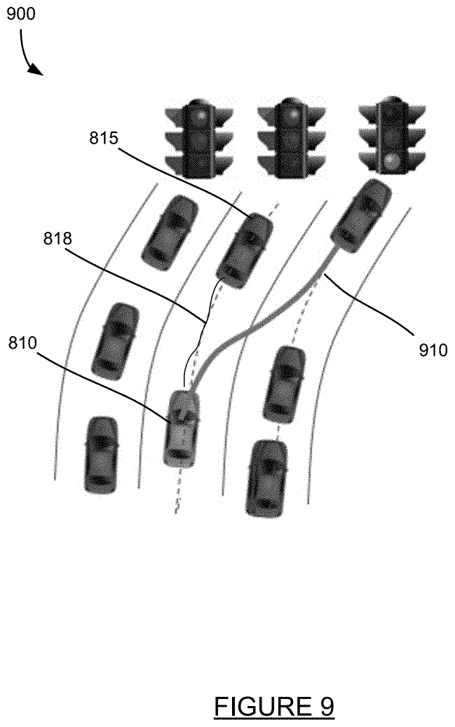

FIG. 9 illustrates a vehicle implementing the technology described herein to plan a lane change with sufficient space 818 between the vehicle 810 and a vehicle 815 in front of it in the same lane. With more space 818, vehicle 810 may navigate from a center reference line in its current lane to a center reference line in the right adjacent lane via selected best trajectory 910.

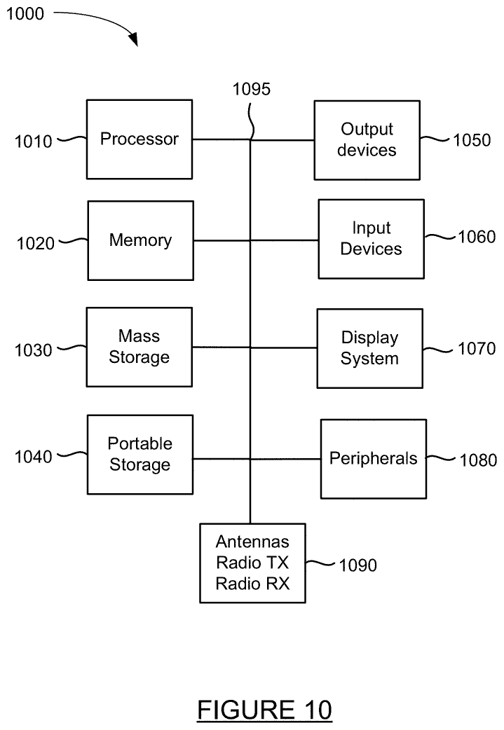

FIG. 10 is a block diagram of a computing environment for implementing a data processing system. System 1000 of FIG. 10 may be implemented in the contexts a machine that implements data processing system 125 on an autonomous vehicle. The computing system 1000 of FIG. 10 includes one or more processors 1010 and memory 1020. Main memory 1020 stores, in part, instructions and data for execution by processor 1010. Main memory 1020 can store the executable code when in operation. The system 1000 of FIG. 10 further includes a mass storage device 1030, portable storage medium drive(s) 1040, output devices 1050, user input devices 1060, a graphics display 1070, and peripheral devices 1080.

The components shown in FIG. 10 are depicted as being connected via a single bus 1090. However, the components may be connected through one or more data transport means. For example, processor unit 1010 and main memory 1020 may be connected via a local microprocessor bus, and the mass storage device 1030, peripheral device(s) 1080, portable storage device 1040, and display system 1070 may be connected via one or more input/output (I/O) buses.

Mass storage device 1030, which may be implemented with a magnetic disk drive, an optical disk drive, a flash drive, or other device, is a non-volatile storage device for storing data and instructions for use by processor unit 1010. Mass storage device 1030 can store the system software for implementing embodiments of the present technology for purposes of loading that software into main memory 1020.

Portable storage device 1040 operates in conjunction with a portable non-volatile storage medium, such as a flash drive, USB drive, memory card or stick, or other portable or removable memory, to input and output data and code to and from the computer system 1000 of FIG. 10. The system software for implementing embodiments of the present technology may be stored on such a portable medium and input to the computer system 1000 via the portable storage device 1040.

Input devices 1060 provide a portion of a user interface. Input devices 1060 may include an alpha-numeric keypad, such as a keyboard, for inputting alpha-numeric and other information, a pointing device such as a mouse, a trackball, stylus, cursor direction keys, microphone, touch-screen, accelerometer, wireless device connected via radio frequency, motion sensing device, and other input devices. Additionally, the system 1000 as shown in FIG. 10 includes output devices 1050. Examples of suitable output devices include speakers, printers, network interfaces, speakers, and monitors.

Display system 1070 may include a liquid crystal display (LCD) or other suitable display device. Display system 1070 receives textual and graphical information and processes the information for output to the display device. Display system 1070 may also receive input as a touch-screen.

Peripherals 1080 may include any type of computer support device to add additional functionality to the computer system. For example, peripheral device(s) 1080 may include a modem or a router, printer, and other device.

The system of 1000 may also include, in some implementations, antennas, radio transmitters and radio receivers 1090. The antennas and radios may be implemented in devices such as smart phones, tablets, and other devices that may communicate wirelessly. The one or more antennas may operate at one or more radio frequencies suitable to send and receive data over cellular networks, Wi-Fi networks, commercial device networks such as a Bluetooth device, and other radio frequency networks. The devices may include one or more radio transmitters and receivers for processing signals sent and received using the antennas.

The components contained in the computer system 1000 of FIG. 10 are those typically found in computer systems that may be suitable for use with embodiments of the present invention and are intended to represent a broad category of such computer components that are well known in the art. Thus, the computer system 1000 of FIG. 10 can be a personal computer, hand held computing device, smart phone, mobile computing device, workstation, server, minicomputer, mainframe computer, or any other computing device. The computer can also include different bus configurations, networked platforms, multi-processor platforms, etc. Various operating systems can be used including Unix, Linux, Windows, Macintosh OS, Android, as well as languages including Java, .NET, C, C++, Node.JS, and other suitable languages.

The foregoing detailed description of the technology herein has been presented for purposes of illustration and description. It is not intended to be exhaustive or to limit the technology to the precise form disclosed. Many modifications and variations are possible in light of the above teaching. The described embodiments were chosen to best explain the principles of the technology and its practical application to thereby enable others skilled in the art to best utilize the technology in various embodiments and with various modifications as are suited to the particular use contemplated. It is intended that the scope of the technology be defined by the claims appended hereto.

1. A system for automatically navigating a vehicle between lanes, comprising:
a data processing system comprising one or more processors, memory, a planning module, and a control module, the data processing system to:
generate longitudinal samplings at different velocities by the vehicle, wherein the longitudinal samplings include a plurality of subsets of longitudinal samplings, wherein each longitudinal sampling subset is associated with a velocity, each longitudinal sampling subset predicts the location of the vehicle in a current lane at one or more points in time at the velocity associated with the particular subset to determine the distance and time at which the current vehicle would reach the closest vehicle in the current lane at the different velocities, wherein each longitudinal sampling subset is associated with a different velocity and different locations at equivalent points in time;
generate a minimum gap distance, between the vehicle and the closest in-path vehicle in the same lane as the vehicle, required to make a lane change for the vehicle, the minimum gap distance generated based on the longitudinal samplings;
select at least one best trajectory from a plurality of trajectories from the current lane to an adjacent lane; and
generate one or more commands to navigate the vehicle from the current lane to the adjacent lane along the selected best trajectory,
wherein the data processing system automatically controls the vehicle to maintain a minimum gap distance between the vehicle and the closest in-path vehicle during the lane change, wherein the best trajectory is selected at least in part based on whether the selected trajectory maintains the minimum gap distance between the vehicle and the closest in-path vehicle.

2. The system of claim 1, the data processing system to:
generate a first reference line in a current lane from received sensor data;
generate a second reference line in a first adjacent lane from the received sensor data; and
generate a third reference line in a second adjacent lane from the received sensor data, wherein the first reference line is a center reference line in the current lane, the second reference line is a center reference line in the first adjacent lane, and the third reference line is a center reference line in the second adjacent lane.

3. The system of claim 1, wherein the best trajectory is selected at least in part due to the minimum gap.

4. The system of claim 1, wherein select at least one best trajectory from a plurality of trajectories includes selecting a first best trajectory between the current and a first adjacent lane and a second best trajectory between the current lane and a second adjacent lane, the first best trajectory having a higher than the second best trajectory.

5. The system of claim 1, further comprising:
determining and storing the minimum gap distance and best trajectory continuously based on an updated position of the closest in-path vehicle and current path of current lane; and
accessing the previously stored minimum gap distance and best trajectory during a next planning cycle by the data processing system.

6. The system of claim 5, wherein the vehicle acceleration, the vehicle yaw rate, and the closest in-path vehicle are determined and stored continuously, and the vehicle acceleration, the vehicle yaw rate, the closest in-path vehicle, minimum gap distance, and best trajectory are received by an adaptive cruise control module during the next computing cycle.

7. The system of claim 1, wherein the at least one best trajectory is selected based on objects detected in each of the plurality of trajectories, constraint considerations, and costs of each trajectory.

8. The system of claim 6, wherein the constraints include a lateral boundary and lateral speed.

9. The system of claim 6, wherein the costs for each trajectory include a change time duration cost and a lateral jerk cost.

10. The system of claim 1, the data processing system generating a longitudinal sampling of different velocities for the vehicle, and selecting the best longitudinal velocity from the sampling of different velocities, the best longitudinal velocity selected at least in part based on maintaining the minimum gap distance.

11. A non-transitory computer readable storage medium having embodied thereon a program, the program being executable by a processor to perform a method for automatically navigating a vehicle between lanes, the method comprising:
generate longitudinal samplings at different velocities by the vehicle, wherein the longitudinal samplings include a plurality of subsets of longitudinal samplings, wherein each longitudinal sampling subset is associated with a velocity, each longitudinal sampling subset predicts the location of the vehicle in a current lane at one or more points in time at the velocity associated with the particular subset to determine the distance and time at which the current vehicle would reach the closest vehicle in the current lane at the different velocities, wherein each longitudinal sampling subset is associated with a different velocity and different locations at equivalent points in time;
generate a minimum gap distance, between the vehicle and the closest in-path vehicle in the same lane as the vehicle, required to make a lane change for the vehicle, the minimum gap distance generated based on the longitudinal samplings;
select at least one best trajectory from a plurality of trajectories from the current lane to an adjacent lane; and
generate one or more commands to navigate the vehicle from the current lane to the adjacent lane along the selected best trajectory,
wherein the data processing system automatically controls the vehicle to maintain a minimum gap distance between the vehicle and the closest in-path vehicle during the lane change, wherein the best trajectory is selected at least in part based on whether the selected trajectory maintains the minimum gap distance between the vehicle and the closest in-path vehicle.

12. The non-transitory computer readable storage medium of claim 11, the method further including:
generating a first reference line in a current lane from received sensor data;
generating a second reference line in a first adjacent lane from the received sensor data; and
generating a third reference line in a second adjacent lane from the received sensor data, wherein the first reference line is a center reference line in the current lane, the second reference line is a center reference line in the first adjacent lane, and the third reference line is a center reference line in the second adjacent lane.

13. The non-transitory computer readable storage medium of claim 11, wherein the best trajectory is selected at least in part on to the minimum gap distance.

14. The non-transitory computer readable storage medium of claim 11, wherein selecting at least one best trajectory from a plurality of trajectories includes selecting a first best trajectory between the current and a first adjacent lane and a second best trajectory between the current lane and a second adjacent lane, the first best trajectory having a higher than the second best trajectory.

15. The non-transitory computer readable storage medium of claim 11, wherein the minimum gap distance and best trajectory are determined and stored continuously, and accessed during a next planning cycle by the data processing system.

16. The non-transitory computer readable storage medium of claim 15, wherein the vehicle acceleration, the vehicle yaw rate, and the closest in-path vehicle are determined and stored continuously, and the determined vehicle acceleration, the vehicle yaw rate, the closest in-path vehicle, minimum gap distance, and best trajectory are received by an adaptive cruise control module during the next computing cycle.

17. The non-transitory computer readable storage medium of claim 11, wherein the at least one best trajectory is selected based on objects detected in each of the plurality of trajectories, constraint considerations, and costs of each trajectory.

18. The non-transitory computer readable storage medium of claim 17, wherein the constraints include a lateral boundary and lateral speed.

19. The non-transitory computer readable storage medium of claim 17, wherein the costs for each trajectory include a change time duration cost and a lateral jerk cost.

20. A method for automatically navigating a vehicle between lanes, comprising:
generating, by a data processing system stored in memory and executed by one or more processors, longitudinal samplings at different velocities by the vehicle, wherein the longitudinal samplings include a plurality of subsets of longitudinal samplings, wherein each longitudinal sampling subset is associated with a velocity to determine the distance and time at which the current vehicle would reach the closest vehicle in the current lane at the different velocities, each longitudinal sampling subset predicts the location of the vehicle in a current lane at one or more points in time at the velocity associated with the particular subset, wherein each longitudinal sampling subset is associated with a different velocity and different locations at equivalent points in time;
generating, by the data processing system, a minimum gap distance, between the vehicle and the closest in-path vehicle in the same lane as the vehicle, required to make a lane change for the vehicle, the minimum gap distance generated based on the longitudinal samplings;
selecting, by the data processing system, at least one best trajectory from a plurality of trajectories from the current lane to an adjacent lane; and
generating, by the data processing system, one or more commands to navigate the vehicle from the current lane to the adjacent lane along the selected best trajectory,
wherein the data processing system automatically controls the vehicle to maintain a minimum gap distance between the vehicle and the closest in-path vehicle during the lane change, wherein the best trajectory is selected at least in part based on whether the selected trajectory maintains the minimum gap distance between the vehicle and the closest in-path vehicle.

21. The method of claim 20, wherein the minimum gap distance and best trajectory are determined and stored continuously, and accessed during a next planning cycle by the data processing system.
